(19) United States
(12) Patent Application Publication
(10) Pub. No.: US 2002/0127362 A1
(43) Pub. Date: Sep. 12, 2002

(54) Flexible laminates and housings for batteries

(75) Inventors: Andrew N. Jansen, Bolingbrook, IL (US); Aron Newman, Shaker Heights, OH (US); Donald Vissers, Naperville, IL (US); Khalil Amine, Downers Grove, IL (US)

Correspondence Address: FOLEY & LARDNER, 150 EAST GILMAN STREET, P.O. BOX 1497, MADISON, WI, 53701-1497, US

(73) Assignee: The University of Chicago

(21) Appl. No.: 10/085,481

(22) Filed: Feb. 28, 2002

Related U.S. Application Data
(60) Provisional application No. 60/272,395, filed on Mar. 1, 2001.

(51) Int. Cl. B32B 9/00

(52) U.S. Cl. 428/40.1; 428/41.7; 428/68; 428/81

(57) ABSTRACT

Flexible polymer laminates for use in battery housings, battery housings made from the laminates, and batteries made from battery cells enclosed within the housings. In one embodiment the laminate is comprised of a barrier polymer sheet with a heat-sealable polymer frame. In other embodiments the laminate is a film of a barrier polymer in contact with a heat-sealable polymer. In various embodiments the barrier polymer is a polyester and the heat-sealable polymer is a polyolefin.

### CROSS-REFERENCES TO RELATED APPLICATIONS

This application claims priority to U.S. Provisional Application No. 60/272,395, filed Mar. 1, 2001, the entire disclosure of which is incorporated herein by reference.

### GOVERNMENT INTERESTS

This invention was made with Government support under Contract No. W-31-109-ENG-38 awarded by the Department of Energy (DOE) and The University of Chicago representing Argonne National Laboratory. The Government has certain rights in this invention.

### FIELD OF THE INVENTION

The present invention relates to flexible polymer laminates for use in battery housings, to battery housings made from the laminates, and to batteries made from battery cells enclosed within the housings. In various embodiments the laminates are made from polyesters and heat-sealable polymers.

### BACKGROUND OF THE INVENTION

In order to provide motive force and for other electrical purposes, electric and hybrid vehicles require an onboard source of electricity which is capable of supplying a large amount of electrical power. Typically, the electrical power is provided by a plurality of batteries, usually lithium ion batteries, housed together in a large battery pack. These battery packs can include a stack of 100 individual cells or more. Battery packs found in electric and hybrid vehicles make a significant contribution to the weight of these vehicles, approaching 50 percent of the total vehicle weight. Additionally, the battery packs in both electric and hybrid vehicles are the single most expensive component of these vehicles. Due to the size of the battery packs in these vehicles and their rigid conformation, the location of the battery packs is limited to specific areas of the vehicle. The location of these battery packs cannot only hinder the handling and performance of these vehicles, it can also make it difficult and expensive to replace individual cells which have become non-functioning.

The materials and processing that go into the production of batteries for hybrid and electric vehicles are extremely costly. Today, most batteries are packaged in deep drawn cans made from either stainless steel or aluminum. These cans are rigid, expensive, and have to go through an expensive process of laser welding in order to be appropriate for use as a battery housing. Furthermore, in order to address safety concerns, current batteries packaged in deep drawn cans require a special safety vent which has to be specifically adapted to the battery housing. Additionally, current battery housings must also incorporate expensive elements to accommodate terminal feedthroughs. Not only are the materials used for current battery housings expensive, batteries based on these housings are expensive to manufacture and the battery that incorporates these housings are quite heavy.

Similar problems and difficulties are also present in batteries used across a wide range of technologies and accordingly are not limited to batteries utilized in electric and hybrid vehicles.

As an alternative to the can-type housing, a battery may be packaged in a flexible housing. Flexible housings may be made of metal foils, layers of plastic or a combination of layers of plastic and layers of metal. The flexible housings currently available typically rely on the same layer of plastic to seal the housing and to act as a barrier to the chemicals commonly associated with electrolytes. This design is inefficient because plastics that are known to make the best seals, typically through heat-sealing, are generally not well suited to withstand chemical attack from electrolytes. Heat-sealable polymers may allow electrolyte solvents to migrate beyond the sealant layer causing corrosion of the battery housing. This is explained by the fact that polymers that are able to be heat-sealed at a practical temperature generally lack high crystallinity, a polymer characteristic that leads to high resistance against chemicals such as electrolyte solvents. Additionally, many flexible battery housings use adhesives to help produce a seal. One major drawback to using an adhesive to seal a battery housing is that solvents from an electrolyte may attack the adhesive, breaching the housing seal.

Thus a need exists for an inexpensive, flexible battery housing that is both heat-sealable and chemically resistant.

### SUMMARY OF THE INVENTION

The present invention provides flexible polyester laminates for use in battery housings as well as battery housings made from those laminates. Specifically, this invention provides a pouch constructed from two different polymers, one of which is a sealant polymer that acts primarily to seal the pouch and one of which is a barrier polymer that prevents chemicals typically found in battery cells from migrating out of the pouch. The advantage realized by the present invention results from the recognition that highly crystalline polymers tend to offer the best chemical resistance against electrolytes and electrolyte solvents, while amorphous polymers generally have lower melting points and therefore are more suited to heat sealing applications. This invention incorporates the advantages of both types of polymer by combining a chemically resistant polymer and a relatively low melting point heat-sealable polymer into a single laminate for use in producing battery housings.

One aspect of the invention provides a laminate composed of a sheet of barrier polymer which has a frame made of sealant polymer. A flexible housing for a battery may be constructed from two of these laminates by heat-sealing the frame of one laminate to the frame of the other laminate such that the two laminates come together to form a pouch made of barrier polymer, the pouch having a perimeter which is encapsulated in and sealed by a frame of sealant polymer. The present invention also provides for batteries made from battery cells sealed in the flexible housings.

Another aspect of the invention provides for a battery cell packaged in a flexible bag made from a sheet of two-ply polymer film. This film is composed of a layer of barrier polymer in contact with a layer of sealant polymer. The film may be formed by coextrusion of the barrier polymer and the sealant polymer. In one embodiment, the bag has a seam running down its length and two oppositely disposed ends. The seam and the ends may be sealed using a combination of lap seals and fin seals.

### BRIEF DESCRIPTION OF THE DRAWINGS

In the drawings:

FIG. 1 shows a laminate made of a barrier polymer sheet having a frame of sealant polymer.

FIG. 2 shows a cross-sectional view of the laminate of FIG. 1 in the area where the sealant polymer frame overlaps the barrier polymer sheet.

FIG. 3 shows a film of laminates.

FIG. 4 shows a cross-sectional view of a portion of a flexible housing made of two of the laminates of FIG. 1.

FIG. 5 shows the lead assembly for a battery packaged in a flexible housing.

FIG. 6 shows a two-ply polymer film composed of a layer of barrier polymer and a layer of sealant polymer.

FIG. 7 shows a bag for use as a battery housing wherein the bag is made of the two-ply polymer film shown in FIG. 6.

FIG. 8 shows how the bag of FIG. 7 may be sealed using a combination of fin and lap seals.

FIG. 9 shows a laminate comprising the two-ply polymer film shown in FIG. 6, two layers of metal foil, and an outer protective layer.

### DETAILED DESCRIPTION OF THE INVENTION

The present invention provides polymer laminates for use in battery housings, battery housings made from those laminates, and batteries made from battery cells packaged and sealed in those housings.

As used herein, the term “battery” may include a single cell, or a number of cells connected in either series or parallel to furnish electrical current. Examples of cells that can be used in the present invention include alkali metal or alkaline earth metal type batteries. In addition, both primary and secondary battery cells may be used. A cell includes an electrolyte, a pair of leads, and an anode and a cathode which extend from the exterior of the pouch to the electrolyte contained in the interior cavity of the pouch to provide electric power.

Each laminate of the present invention is constructed from at least two different polymers. The first polymer, known as the barrier polymer, is chemically resistant to chemicals typically found in battery cells, including electrolytes, electrolyte solvents, and their decomposition products, such as hydrogen fluoride and organic carbonates. Polymers having a high degree of crystallinity are suitable barrier polymers because they have been found to be highly impermeable to the chemical components typically found in battery cells. Suitable barrier polymers are well known in the art. These include, but are not limited to oriented polyethylene terephthalate (oPET) and oriented polypropylene (oPP). However, because highly crystalline polymers have relatively high melting points (generally greater than 170° C.), they are not ideally suited for heat sealing applications. For this reason, a second, more readily heat-sealable polymer should be incorporated into the laminate structure. This polymer is known as the sealant polymer. Amorphous polymers, including copolyesters, generally have lower melting points than highly crystalline polymers and therefore make better sealant polymers. Typical melting points for the sealant polymers of the present invention are below about 180° C., or even below about 140° C. These sealant polymers can be readily heat-sealed at temperatures below about 220° C. Some sealant polymers can be heat sealed at temperatures below about 190° C. Still other sealant polymers can be heat sealed at temperatures below about 170° C. Polymers that are heat-sealable at these temperatures are well known in the art. These include, but are not limited to, polyolefins, e.g. polypropylene, polyethylene, copolymers of ethylene and propylene; surlyn, and extrudable epoxies such as Dow Chemical's BLOX™. In one embodiment, the heat-sealable polymer is a copolyester. One example of a suitable copolyester is ethylene-co-diethylene terephthalate.

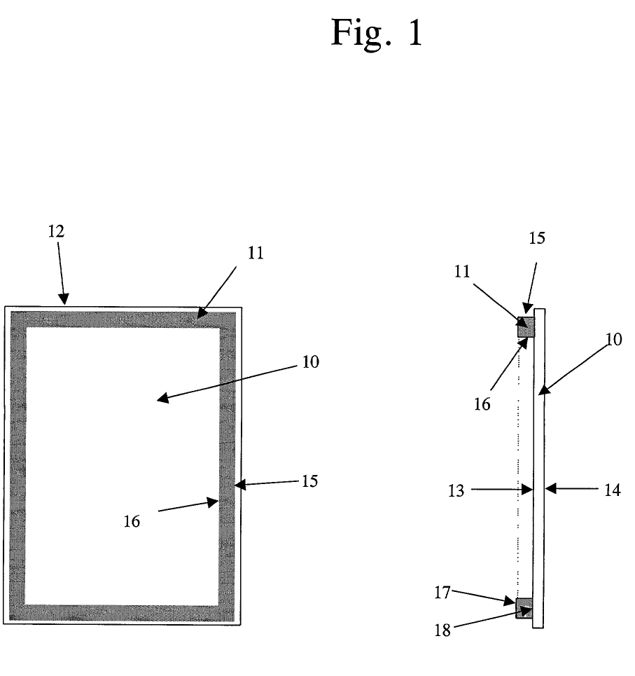

One embodiment of the present invention provides a laminate composed of a sheet of barrier polymer 10 having a frame 11 made of sealant polymer, as shown in FIG. 1. In this embodiment, the sheet of barrier polymer is characterized by an outside edge or periphery 12, a first surface 13 and a second surface 14. One skilled in the art would recognize that the barrier polymer sheet may have a range of thicknesses depending on its intended application, however, in various embodiments of this invention the thickness of the sheet will be less than 150 micrometers, and may be less than 50 micrometers. It will also be recognized by one of skill in the art that the sheet of barrier polymer may take on a variety of shapes. In various embodiments, the sheet of barrier polymer is approximately rectangular in shape, and is characterized by a length and a width.

The frame 11 of sealant polymer is characterized by an outside edge 15, and an inside edge 16 that defines an aperture, a thickness, and a first 17 and a second 18 surface. One skilled in the art would recognize that the sealant polymer frame may have a range of thicknesses depending on its intended application, however, in various embodiments of this invention the thickness of the sealant polymer frame will be less than about 200 micrometers and may be less than about 50 micrometers. In various embodiments, the sealant polymer frame has a thickness between about 50 and about 10 micrometers. The frame 11 of sealant polymer may be roughly the same shape as the sheet 10 of barrier polymer. In one embodiment of the invention, the thickness of the frame is tapered toward the frame aperture such that the thickness of the frame is at a minimum around the aperture. In this embodiment the frame thickness around the aperture may be less than about 10 micrometers and may be between about 2 and about 6 micrometers. A rectangular frame that defines an aperture will be characterized by an outside length and an outside width, in addition to an aperture length and width. In order to properly form a frame of sealant polymer around the sheet of barrier polymer, the dimensions of the perimeter of the frame may be less than or greater than the dimensions of the perimeter of the sheet of barrier polymer, while the frame aperture should be smaller than the perimeter of the sheet of barrier polymer.

A laminate can be constructed from a frame of sealant polymer 11 and a sheet of barrier polymer 10 by disposing the frame 17 above the sheet 13 such that the entire frame aperture lies above the first surface of the sheet and is centered over the sheet. The resulting laminate is characterized by an external surface and an internal surface. The laminate may then be run through a roller to ensure good contact between the sheet of barrier polymer and frame of sealant polymer. The frame 11 and the sheet 10 can then be attached by melting the frame of sealant polymer onto the sheet of barrier polymer. Although it is possible to use adhesive to help attach the frame to the sheet, adhesives are not necessary and may be omitted.

Various embodiments of the laminate may include at least one layer of metal foil attached to at least a portion of the external surface of the laminate. The metal foil acts as a protective layer and a barrier to moisture and solvent vapors. The foil may be attached with an adhesive 20. The adhesive should be applied as a thin coating on the foil that does not permit the transport of moisture through its edges. Suitable adhesives include polyurethanes, epoxy resins, polysulfide systems, reactive acrylate adhesives, UV curable adhesives, cyanoacryolates, and silicone adhesives.

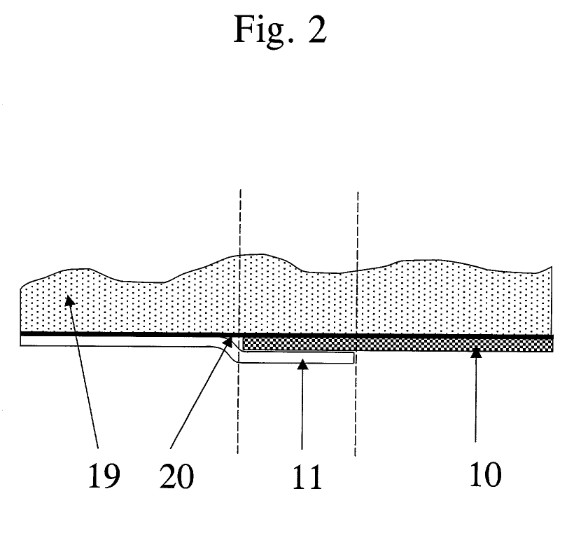

FIG. 2 shows a cross-sectional view of a laminate in the area where a sealant polymer frame 11 overlaps a barrier polymer sheet 10. Likewise, it is possible to have an embodiment where the barrier polymer sheet overlaps the sealant polymer frame. The laminate in the figure includes a layer of metal foil 19 attached by a thin layer of adhesive 20 to the external surface of the laminate.

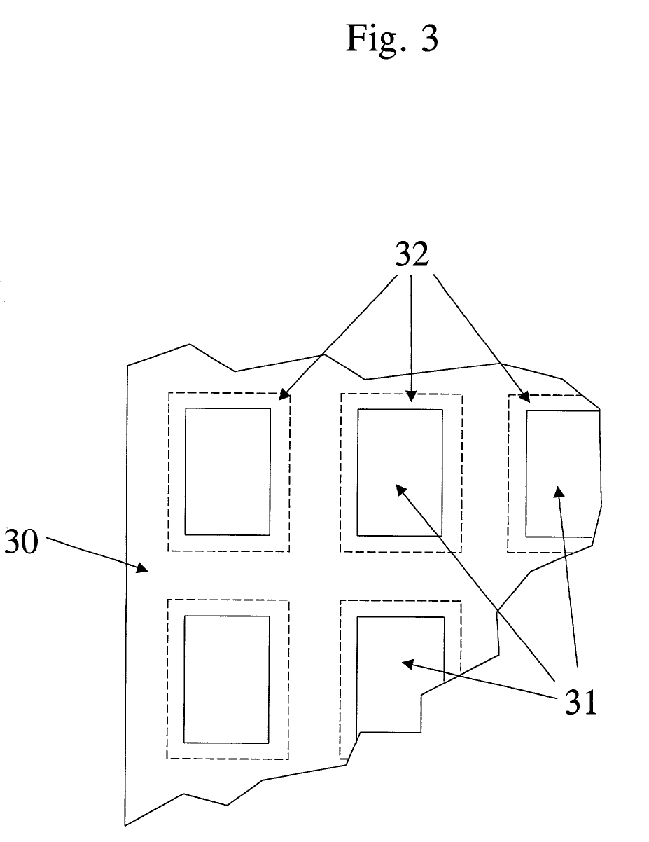

The laminates may be produced individually, as described above, or they may be mass produced by forming a film containing a plurality of laminates, as shown in FIG. 3. A film of laminates may be produced by cutting a series of apertures 31 into a film of sealant polymer 30. For example, the apertures may be cut into the film by a die cutter. One of skill in the art would recognize that the shape of the apertures is not critical, however in various embodiments the apertures are approximately rectangular in shape. Preferably the apertures are of uniform size and are uniformly spaced in the film. Next, a sheet of barrier polymer 32 may be placed over each of the apertures in the sealant film. In one embodiment, the barrier polymer sheets are attached to a film of metal foil by an adhesive. The sealant film and the barrier sheets can then be run through a rubber roller. This ensures good contact between the sealant film and the barrier sheets. Next, the sealant film and the barrier sheets may be thermally fused together. The laminates may be separated by cutting or punching the individual laminates out of the resulting film. In another method of mass producing these laminates, the sealant frames can be formed from the extrusion of hot melt sealant polymers or epoxy resins directly onto the barrier sheet.

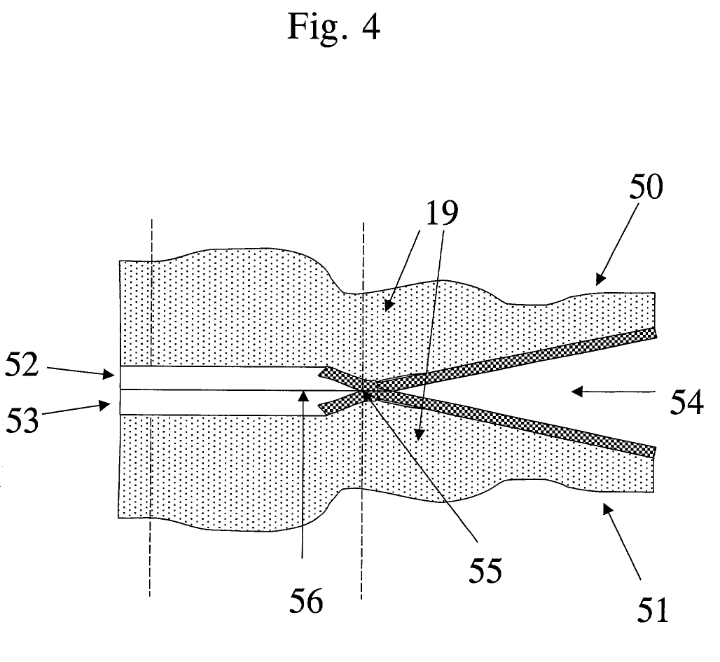

FIG. 4 shows a cross-sectional view of a part of a pouch 54 made of two of the above described laminates 50 and 51 in the area where the barrier polymer sheets of the two laminates come together. The pouch is made by heat-sealing the frame of a first laminate 52 to the frame of a second laminate 53, such that the outside edges or peripheries of the barrier polymer sheets of the two laminates meet and form a pouch 54, the pouch having a perimeter 55 defined by the area of contact between the two barrier polymer sheets. In such an embodiment the perimeter of the pouch is encapsulated by and sealed by a frame 56 of sealant polymer. In certain embodiments the peripheries of the barrier polymer sheet are pinched together before the frames are heat-sealed. In some embodiments the frames are tapered toward the frame apertures, minimizing the thickness of the sealed frame at the perimeter of the pouch. These designs substantially eliminate contact between the sealant polymer and the electrolytes, electrolyte solvents, and electrolyte decomposition products, minimizing the risk of chemical attack on the seal.

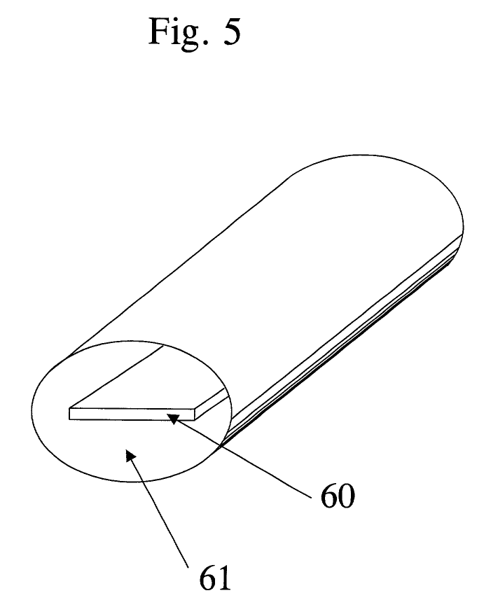

The present invention also provides a battery made of a cell or a number of cells sealed in the above described flexible housing. When a battery cell is packaged in a housing, it is desirable to have the battery leads extend through the housing without compromising the seal. FIG. 5 shows a lead assembly for use with this invention. At least a portion of each of the battery leads 60 is wrapped in a film of heat-sealable polymer 61. In this design the heat-sealable polymer film and the sealant polymer frames may be made of the same polymer. The leads are then heated to a temperature high enough to fuse the leads to the heat-sealable polymer film. For example, the leads wrapped with the film can be mounted in a high temperature die and heated by induction. A cell is then placed inside the housing with its leads extending beyond the housing such that wrapped portions of the leads are located between the frames of the two laminates. In this configuration, the leads will become bonded to and sealed within the frames when the frames are heat-sealed together.

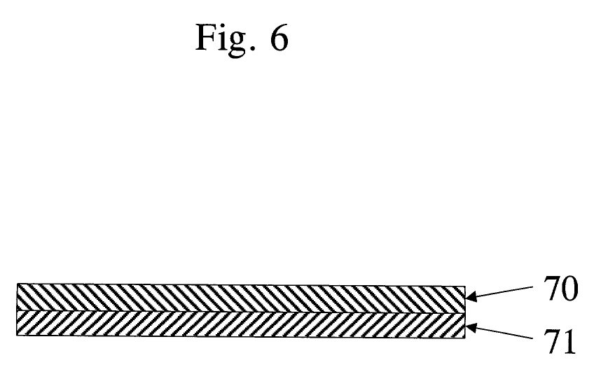

Another aspect of this invention provides a cell or a number of cells packaged in a flexible bag made from a two-ply polymer film. FIG. 6 shows such a film. This film is composed of a layer of barrier polymer 70 in contact with a layer of sealant polymer 71. The bag has an inside surface of sealant polymer that defines an internal cavity, and an outside surface of barrier polymer. In this embodiment, the sealant polymer and the barrier polymer are defined as above.

In one embodiment, the barrier layer is a polyester and the sealant layer is a heat-sealable polymer. Polyethylene terephthalate (PET) is an example of a suitable polyester that can be used as the barrier layer, and polyolefins are an example of a suitable heat-sealable polymer that can be used as a sealant. Other suitable sealants include, but are not limited to, polypropylene, polyethylene, copolymers of ethylene and propylene, surlyn, and extrudable epoxies such as Dow Chemical's BLOX™. The polyester/sealant coextrusion film described in U.S. Pat. No. 4,765,999, which is herein incorporated by reference, is an example of a two-ply polymer film suitable for use in the present invention. The two-ply film may be produced without adhesives by thermally fusing the barrier and sealant polymer layers. This can be accomplished using coextrusion techniques well known in the art, including, but not limited to, cast coextrusion techniques and blown film coextrusion techniques.

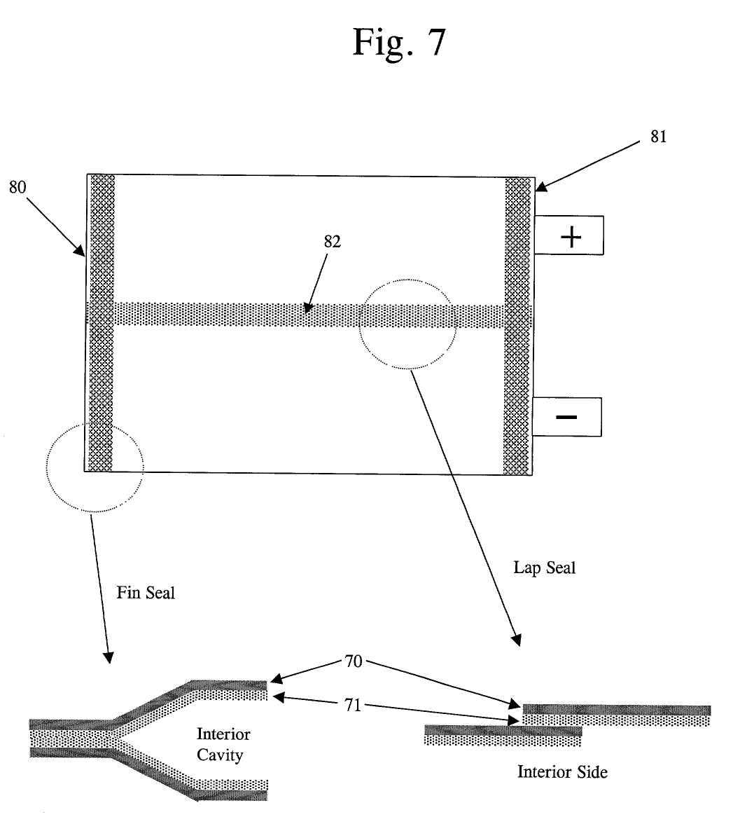

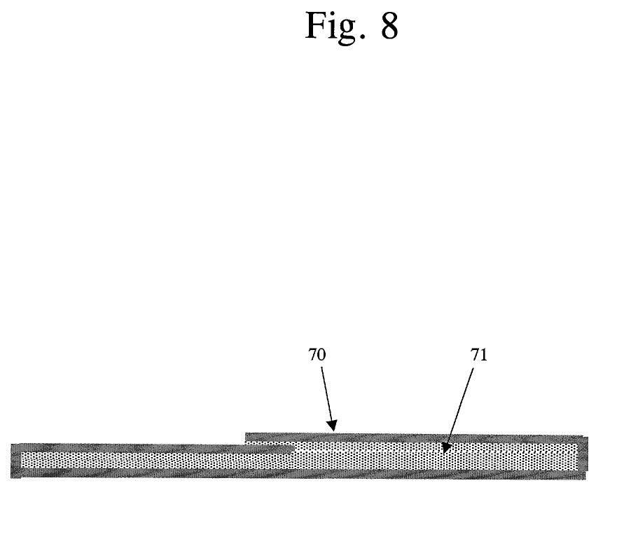

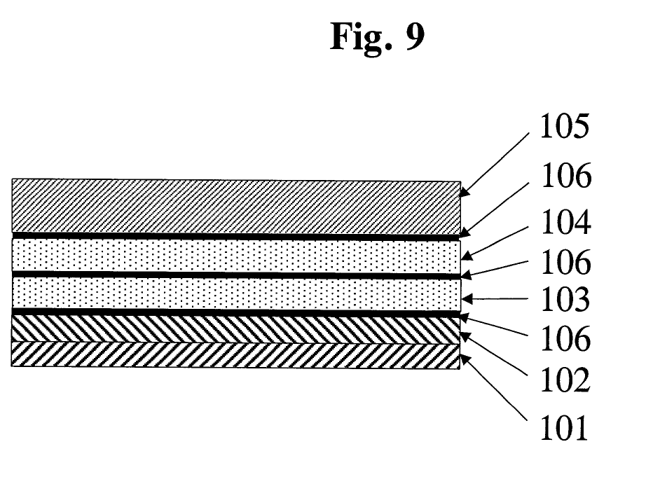

This aspect of the invention provides for battery cells packaged in bags having a range of shapes and dimensions. FIG. 7 shows an example of a bag suitable for use in the present invention. The bag has two oppositely disposed ends 80 and 81 and a lengthwise seam 82. The ends and the seam may be sealed using lap seals, fin seals, or a combination of fin and lap seals. Such seals are well known in the art. In one embodiment, the lengthwise seam is sealed using a lap seal in which the sealant layer of polymer is bonded to the outside surface of the pouch and the ends of the pouch are sealed using conventional fin seals in which the sealant layer of the laminate is sealed to itself. FIG. 8 shows an embodiment wherein a lap seal encapsulates the fin seal on each end of the pouch. In other embodiments, the bag is made of a film having at least one layer of metal foil attached to the layer of barrier polymer, the metal foil forming the outside surface of the bag. FIG. 9 shows yet another embodiment of the film used in the invention. The film includes a sealant layer 101, a barrier layer 102, a first layer of metal foil 103, a second layer of metal foil 104, and a protective layer 105. Suitable materials for the protective layer include, but are not limited to, polyesters, polyamides, polyvinylchlorides, fluoroplastics, polyacrylonitriles and polyolefins. Examples of suitable polymers include, low density polyethylene, high density polyethylene, medium density polyethylene, linear low density polyethylene (LLDPE), copolymers of ethylene and alpha-olefins, two-ply high density polyethylene/linear low density polyethylene, ethylene interpolymers (ionomers) (e.g., surlyn), polyethylene terephthalate, polypropylene, polyacrylonitrile, polychloro-trifluoroethylene, polyphenylene sulfide, ethylene vinyl acetate, ethylene vinyl alcohol, nitrile resin films, nylon, and combinations thereof. Rubber may also be suitable for the protective layer. Suitable metal foils include, but are not limited to, foils made of aluminum, stainless steel, nickel, copper, and alloys thereof. Attachment of the barrier sheet, one or more metal foils, and the outer protective layer may be accomplished using an appropriate adhesive 106.

Again, it is desirable to have the battery leads extend through the housing without compromising the seal. This can be accomplished by wrapping at least a portion of each of the battery leads in a film of heat-sealable polymer, in the manner described above. When the cell is placed in the internal cavity of the pouch, it should be arranged such that leads extend beyond one end of the pouch and the wrapped portions of the leads are located in the center of the fin seal. In this configuration, the leads can be sealed into a fin seal during the heat-sealing process.

The application of the flexible packaging of the present invention is not particularly limited. This laminate assembly can be utilized for primary or secondary batteries of aqueous or nonaqueous chemistries. Examples of aqueous primary batteries include, but are not limited to, alkaline, zinc-carbon, mercuric oxide, silver oxide, and zinc-air. Examples of aqueous secondary batteries include, but are not limited to, nickel cadmium, lead acid, nickel-iron, and nickel metal hydride. Examples of non-aqueous primary batteries include, but are not limited to, lithium/iron sulfide, lithium/vanadium oxide, and lithium/manganese dioxide. Examples of non-aqueous secondary batteries include, but are not limited to, lithium ion, lithium polymer, and lithium-ion polymer.

While preferred embodiments have been illustrated and described, it should be understood that changes and modifications can be made therein in accordance with ordinary skill in the art without departing from the invention in its broader aspects as defined in the following claims.

What is claimed is:

1. A laminate for use in a flexible battery housing comprising:
(a) a barrier polymer sheet that is substantially inert to electrolytes, the sheet having a perimeter; and
(b) a heat-sealable sealant polymer frame disposed around the perimeter of the barrier polymer sheet.

2. The laminate of claim 1 wherein the sealant polymer has a lower melting point than the barrier polymer.

3. The laminate of claim 1 wherein the barrier polymer is a crystalline polymer and the sealant polymer is an amorphous polymer.

4. The laminate of claim 1 wherein the barrier polymer is a polyester and the sealant polymer is a polyolefin.

5. The laminate of claim 1 wherein the barrier polymer is polyethylene terephthalate and the sealant polymer is a polyethylene.

6. The laminate of claim 1 wherein the sealant polymer has a melting point of less than about 180° C.

7. The laminate of claim 1, further comprising at least one layer of metal foil attached to a portion of the laminate.

8. A film comprising a plurality of the laminates of claim 1.

9. A flexible housing for a battery comprising:
a) a pouch comprised of a barrier polymer that is substantially inert to electrolytes, the pouch having a perimeter; and
b) a frame of heat-sealable sealant polymer, the frame sealing at least a portion of the perimeter of the pouch to form a flexible housing.

10. The flexible housing of claim 9 wherein the barrier polymer is a crystalline polymer and the sealant polymer is an amorphous polymer.

11. The flexible housing of claim 9 wherein the barrier polymer is a polyester and the sealant polymer is a polyolefin.

12. The flexible housing of claim 9 wherein the barrier polymer is polyethylene terephthalate and the sealant polymer is a polyethylene.

13. The flexible housing of claim 9 wherein the sealant polymer frame can be heat-sealed at a temperature of less than about 220° C.

14. The flexible housing of claim 9, further comprising at least one layer of metal foil attached to an external surface of the housing.

15. A battery comprising at least one battery cell sealed in the flexible housing of claim 9.

16. A battery comprising at least one battery cell sealed in a flexible bag, the bag comprising a layer of barrier polymer that is substantially inert to electrolytes in contact with a layer of heat-sealable sealant polymer, the bag having an inside surface defining an internal cavity, the inside surface comprised of the layer of sealant polymer.

17. The battery of claim 16, wherein the barrier polymer is a crystalline polymer and the sealant polymer is an amorphous polymer.

18. The battery of claim 16, wherein the barrier polymer is a polyester and the sealant polymer is a polyolefin.

19. The battery of claim 16 wherein the barrier polymer is polyethylene terephthalate and the sealant polymer is a polyethylene.

20. The battery of claim 16 wherein the barrier polymer is a polyester and the sealant polymer is a copolyester.
